(19) United States
(12) Patent Application Publication
(10) Pub. No.: US 2004/0216067 A1
(43) Pub. Date: Oct. 28, 2004

(54) Method of determining arrangement of wire in semiconductor intergrated circuit

(75) Inventors: Genichi Tanaka, Hyogo (JP); Yoshihide Ajioka, Hyogo (JP)

Correspondence Address: McDermott Will & Emery, 600 13th Street, N.W., Washington, DC, 20005-3098, US

(73) Assignee: RENESAS TECHNOLOGY CORP.

(21) Appl. No.: 10/831,164

(22) Filed: Apr. 26, 2004

(30) Foreign Application Priority Data
Apr. 28, 2003 (JP) 2003-123512(P)

(51) Int. Cl. G06F 17/50

(52) U.S. Cl. 716/10; 716/13; 716/6

(57) ABSTRACT

A method employed to determine a wire arrangement includes the steps of: arranging cells; performing a general routing; using maximum and minimum values of resistance, capacitance and other values stored in a library to calculate maximum and minimum delay times, the resistance, capacitance and other values being previously calculated through a simulation performed as a process parameter and a determinant of geometry as seen in plane are varied; if maximum delay and minimum delay times fall within a tolerable timing range, then performing a specific routing.

### BACKGROUND OF THE INVENTION

1. Field of the Invention

The present invention relates generally to methods of determining wire arrangements that lay out semiconductor integrated circuits, and particularly to such methods that take into consideration variation of process parameters of semiconductor integrated circuit fabrication equipment to lay out semiconductor integrated circuits to implement correct operation timing.

2. Description of the Background Art

In the field of production of semiconductor integrated circuits in recent years the technology of microfabrication of transistors, wires and other elements continues to advance. As these elements are increasingly microfabricated, transistors included in logic cells provide reduced delay time. However, wires have a reduced distance therebetween and are also reduced in width. Accordingly, interwire capacitance and wire resistance are increased and wiring delay tends to increase. Consequently, as microfabrication advances, a semiconductor integrated circuit provides wiring delay time accounting for increased degrees of its entire delay time. Accordingly, it is important to correctly estimate wiring delay time.

To verify a timing of operation of a semiconductor integrated circuit, process variation, or variation in temperature, power supply or the like is considered to calculate delay time. More specifically, when wiring delay time is considered to perform a timing verification, consideration is given to variation in thickness or width of a film of a wire or that in thickness, permittivity or the like of an interlayer film in production equipment used in a thin-film formation process to calculate wire resistance and interwire capacitance, and the wire resistance and interwire capacitance are also used to calculate wiring delay time. In doing so, a technique is used to obtain the wire resistance and the interwire capacitance, as based on variation in amount of a process variation factor determined by the semiconductor integrated circuit fabrication equipment of interest and causing at least one of the wire resistance and the interwire capacitance, to perform a circuit simulation.

Japanese Patent Laying-Open No. 2001-306647 discloses a timing verification method taking process variation into consideration to efficiently perform a timing verification. This method verifies a timing of operation of a semiconductor integrated circuit including a plurality of cells having a logic function and also having their respective terminals wired, and includes the steps of: setting an amount of process variation, i.e., variation in amount of a process variation factor determined by the semiconductor integrated circuit fabrication process of interest and causing at least one of wire resistance and interwire capacitance to vary; using the amount of process variation and wire's graphical layout to calculate the wire resistance and the interwire capacitance, and using the calculated wire resistance and interwire capacitance to calculate a first delay time of the wire and a second delay time of a cell driving the wire, at least twice with process variation varied in amount, to calculate at least two variation delay times including the first and second delay times; generating from the at least two variation delay times a combined delay time that determines the circuit's operation characteristics; and using the combined delay time to perform the circuit's delay simulation.

In the above method, at least two variation delay times corresponding to different amounts of process variation or different process variation conditions, respectively, are calculated and therefrom a combined delay time that determines a semiconductor integrated circuit's operation characteristics is generated and then used to perform the circuit's delay simulation. The calculation of variation delay time corresponding to process variation condition and the circuit's delay simulation can independently be performed and in addition thereto only a combined delay time generated from at least two variation delay times can be used to perform delay simulation. This can eliminate the necessity of repeatedly performing a delay or circuit simulation for a plurality of process variation conditions. A timing verification with process variation considered can efficiently be performed.

Furthermore, Japanese Patent Laying-Open No. 2000-172738 discloses a method of automatically laying out a large scale integrated circuit (LSI) that does not allow a delay violation path to be generated. This method includes the steps of: inputting information required to design a layout; automatically arranging all cells; initially, generally routing all nets; calculating each path's delay time and extracting a critical path violating each path's delay constraint value; determining the presence/absence of a delay violation path to return the control to the step of automatically arranging when there is a critical path and to proceed with the subsequent step of improved general routing when there is no critical path; improved general routing to assign a net with a severe delay constraint value an initial, general wiring route and a wiring layer minimized in wiring delay and assign the other net(s) a general wiring route and wiring layer of net to alleviate crowdedness of wiring; and determining a specific wiring route from general wiring route.

In this method, for a net with a severe delay constraint a wiring layer advantageous in terms of delay is assigned a wiring route shortest in wiring length, and for a net with a less severe delay constraint, crowdedness of wiring is considered in routing. An LSI's capability to accommodate wires is not impaired and a delay constraint is also not violated in laying out.

Japanese Patent Laying-Open No. 2001-306647 discloses a timing verification method setting an amount of process variation to calculate at least two variation delay times to set one of minimum and maximum values thereof as a combined delay time. The maximum is selected as a combined delay time to verify maximum delay and the minimum is selected as a combined delay time to verify minimum delay. In such a process if an amount of process variation is set, an average thereof, and the average plus 3σ is set as a maximum value, and the average minus 3σ is set as a minimum value, and wiring RC data (wire resistance data and wiring capacitance data) are calculated, as correlated with the maximum and minimum values, and then used to calculate delay time. Accordingly, when this method is performed the wiring RC data must be calculated each time.

Japanese Patent Laying-Open No. 2000-172738 discloses an automatic LSI layout method, which insufficiently considers variation in wire resistance wiring capacitance and the like that is associated with variation of a process parameter in the LSI's fabrication process.

### SUMMARY OF THE INVENTION

The present invention contemplates a method of determining a wire arrangement that considers variation of a process parameter of a semiconductor integrated circuit-fabrication process in performing a timing verification of the semiconductor integrated circuit to determine a hierarchal wire arrangement for the circuit.

The present method includes the steps of: automatically arranging a plurality of cells of a semiconductor integrated circuit, as based on a net list describing how the cells are connected, the semiconductor integrated circuit having a plurality of wiring layers used to wire the cells; setting a general route including a lateral wire arrangement connecting cells located between the plurality of wiring layers; previously creating information of a delay factor employed to calculate a value of delay between the cells from the general routing, the information varying with a process parameter in a process for fabricating the semiconductor integrated circuit, the information being created in a form applicable to a different semiconductor integrated circuit; calculating the net's delay value from the information and the general routing; and if the delay value falls within a predetermined tolerable range, determining a specific routing between the cells, as based on the set general routing, in accordance with a rule in a technology file describing a design rule.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for control of a computer system implementing a method of determining a wire arrangement in accordance with an embodiment of the present invention

FIG. 2 is a layout showing a portion of a semiconductor integrated circuit designed in a layout.

FIG. 3 shows a concept representing a result of an arrangement of standard cells.

FIG. 4 shows a concept representing a result of general routing

FIG. 5 shows a concept for illustrating a trunk Steiner tree algorithm.

FIGS. 6A and 6B show a concept for calculating a wire's delay value.

FIG. 7 is a flow chart of a program of a library creation process performed in the present method in accordance with an embodiment of the present invention.

FIG. 8 is a flow chart of a program of a process performed to determine a wire arrangement, as performed by the present method in accordance with an embodiment of the present invention.

FIGS. 9-12 show contents of a library.

### DESCRIPTION OF THE PREFERRED EMBODIMENTS

Hereinafter reference will be made to the drawings to describe an embodiment of the present invention. In the following description and the drawings, like components are denoted by like reference characters and are also identical in name and function.

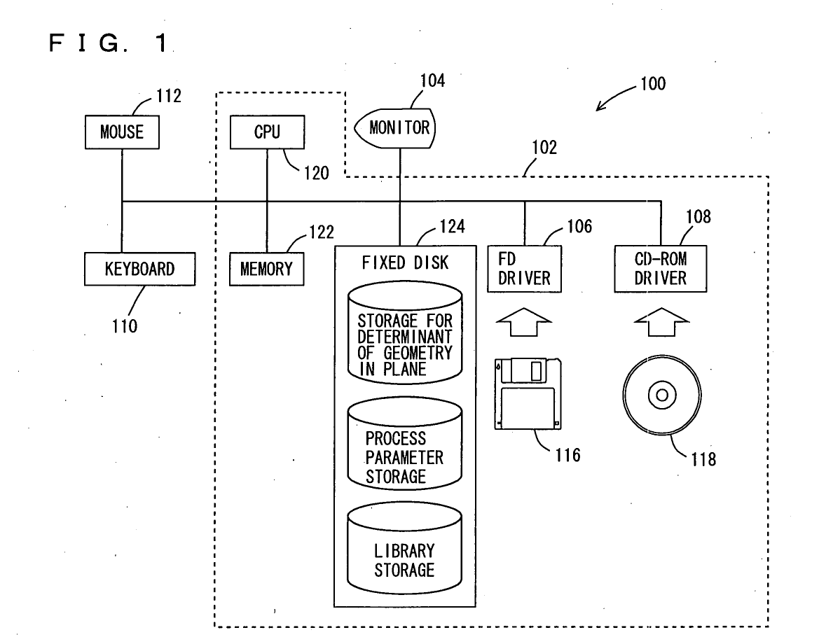

FIG. 1 is a block diagram of a computer system as one example of hardware implementing a method employed to determine a wire arrangement in accordance with the present embodiment. With reference to FIG. 1, a computer system 100 includes a computer 102 equipped with a flexible disk (FD) driver 106 and a compact disc-read only memory (CD-ROM) driver 108, a monitor 104, a keyboard 110, and a mouse 112. In addition to FD and CD-ROM drivers 106 and 108, computer 102 includes a central processing unit (CPU) 120, a memory 122 and a fixed disk 124 interconnected together by a bus.

FD driver 106 receives an FD 116. CD-ROM driver 108 receives a CD-ROM 118. Fixed disk 124 has a storage for a determinant of geometry as seen in plane, a process parameter storage, and a library storage.

In the present embodiment the present method is implemented by computer hardware and software executed by CPU 120. Typically, such software is stored in FD 116, CD-ROM 118 or other similar recording media and distributed, and read by FD or CD-ROM driver 106 or 108 or the like from the recording media and temporarily stored in fixed disk 124. Furthermore, it is read from fixed disk 124 into memory 122 and executed by CPU 120. The FIG. 1 computer's hardware itself is typical hardware. As such, the present invention's essential portion can also be said to be software recorded in FD 116, CD-ROM 118, fixed disk 124 or other similar recording media.

The FIG. 1 computer's operation will not specifically be described as it is well known.

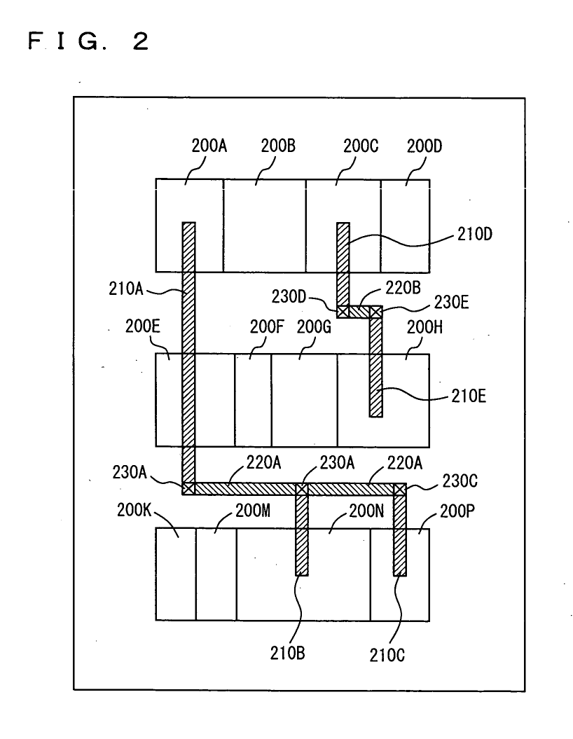

The present method in an embodiment that is implemented by the above described computer is applied to a semiconductor integrated circuit as will be described hereinafter. For the semiconductor integrated circuit, a standard cell is used to automatically determine a wire arrangement. FIG. 2 is a layout showing a portion of a semiconductor integrated circuit designed in layout. In FIG. 2, standard cells 200A-200P are automatically arranged cells. Metal 210A, 210E for a second layer is automatically routed in a prescribed metal pattern at a second wiring layer. Metal 220A-220B for a first layer is automatically routed in a prescribed metal pattern at a first wiring layer. Vias 230A-230Eelectrically connect together metal 220A, 220B for the first layer and metal 210A-210E for the second layer.

Typically, to lay out a semiconductor integrated circuit in the standard cell system, as shown in FIG. 2, standard cells previously designed and substantially equal in height are arranged in a line and set as a row/column of cells and such rows/columns of cells are arranged in parallel. The rows/columns of cells have a space therebetween, which is used as an interconnect channel to wire the cells. Typically, a standard cell has power source and grounding terminals on its right and left sides, positioned symmetrically, and when such cells are arranged in a horizontal direction adjacently a module will have internal power source and grounding lines connect of themselves.

One object of automatic arrangement is to provide reduced chip area. This entails determining an order of arrangement of cells on rows/columns of cells to provide a minimized sum of the heights of all interconnect channels.

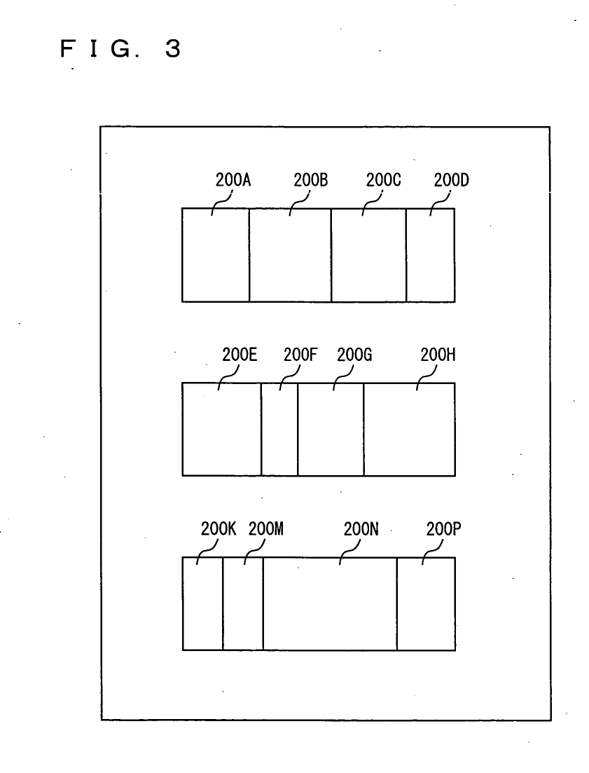

To do so, initially a net list extracted from a logic diagram is referred to to arrange standard cells in order to (1) provide a reduced chip area and (2) minimize a net's wiring length, as shown in FIG. 3. For this arrangement, such techniques can be used as configurative arrangement at initial arrangement (e.g., a random method, a pair-linking method, a cluster growth method, a mincut method and the like) and repeated improvement in improvement of arrangement (a Steinberg method, a pair exchange method, an iterated barycenter method, a simulated annealing method and the like).

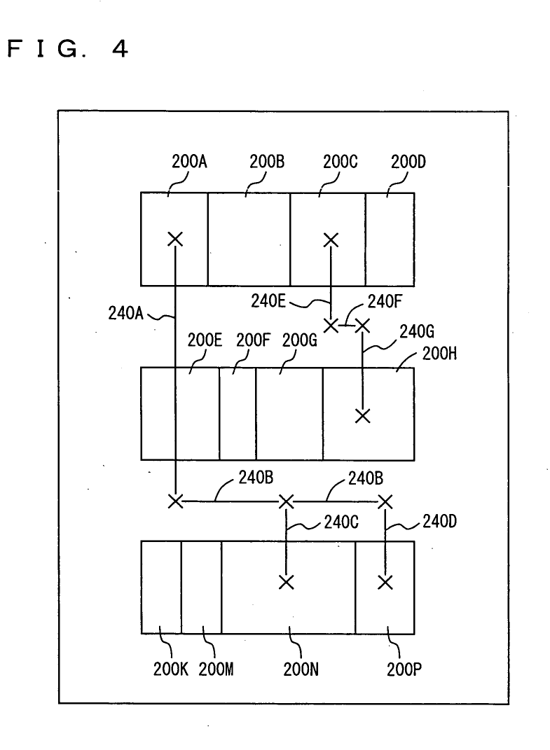

After the cells have been arranged, general routing is performed. In general routing, a wiring route is determined for each net. For example, general routing as one example is performed by such a process as follows: when general routing is performed to determine a wiring route, a multi-terminal net is initially disintegrated into trees of a 2-terminal net for reconfiguration. This tree's model includes forming from branches connecting terminals a minimum tree allowing Manhattan distance to provide a minimized entire length, forming a chain tree connecting all terminals unicursally, forming a Steiner tree providing a minimum length such that branching at other than terminal of cell is also allowed. FIG. 4 shows a concept of completed general routing. In FIG. 4, wirings 240A-240D are wiring of two nets wired as determined by general routing.

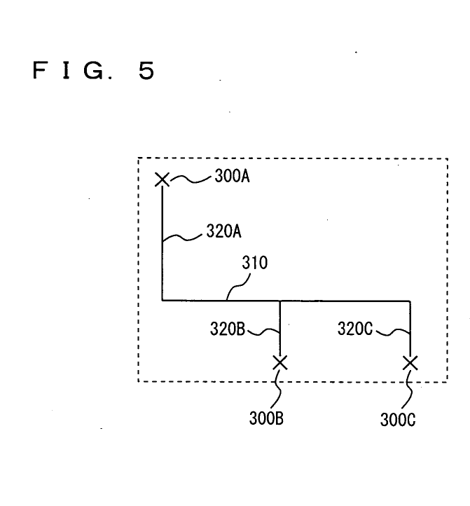

FIG. 5 shows a trunk Steiner tree by way of example. This tree is formed as follows: initially surround pin 300A, 300B, 300C by a rectangle. Draw a line 310 in the same direction as the rectangle's long side to follow an average value of the coordinates of pins 300A-300C and draw from pins 300A-300C line 320A-320C normal to line 310.

After general routing has thus been done, an apparatus that determines a wire arrangement in accordance with the present embodiment performs a timing verification. To perform the timing verification, delay of parasitic elements (wire resistance, wiring capacitance) needs to be considered. In the present embodiment, the parasitic elements' values used are librarized so that they can be used among different semiconductor integrated circuits (common in minimum line width of design rule). A parasitic element is a cause of delay introduced for example by resistance, capacitance and the like associated with wiring required to interconnect devices, cells and the like, rather than an integrated circuit's essential elements such as transistors.

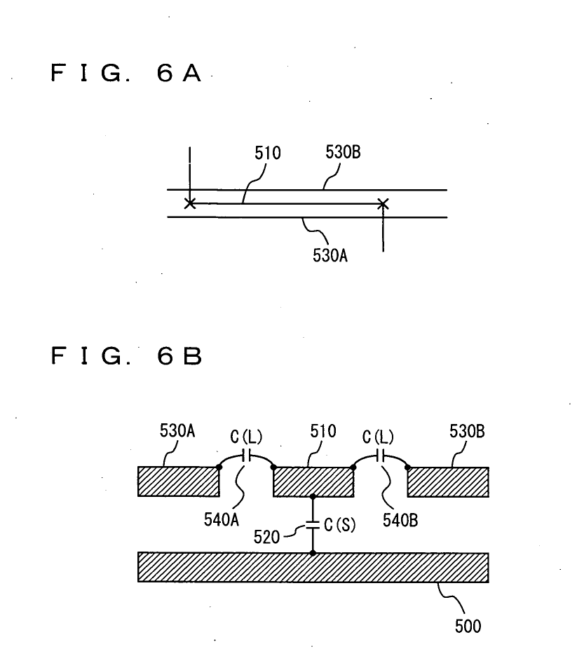

FIGS. 6A and 6B represent a concept for calculating a wire's delay value, in a planar view and in cross section, respectively. The calculation is performed assuming that a wire 5 10 to be calculated is adjacent to the same layer's other wires 530A, 530D in parallel at minimum intervals. In FIGS. 6A and 6B, capacitance C (L) 540A is capacitance between adjacent wires 510 and 530A per unit length, and capacitance C (L) 540B is capacitance between adjacent wires 510 and 530B per unit length. The capacitances C (L) are equal in value. Furthermore, with reference to FIG. 6B, capacitance C (S) 520 is capacitance introduced between wire 510 and a substrate 500 per unit area.

For such a delay factor a delay value is calculated using resistance and capacitance values librarized for each value of wiring length, wiring width, wiring interval, the possibility of adjacent wiring, the possibility of overlapped wiring, and cell.

Hereinafter a method employed to determine a wire arrangement in accordance with the present embodiment will be described more specifically.

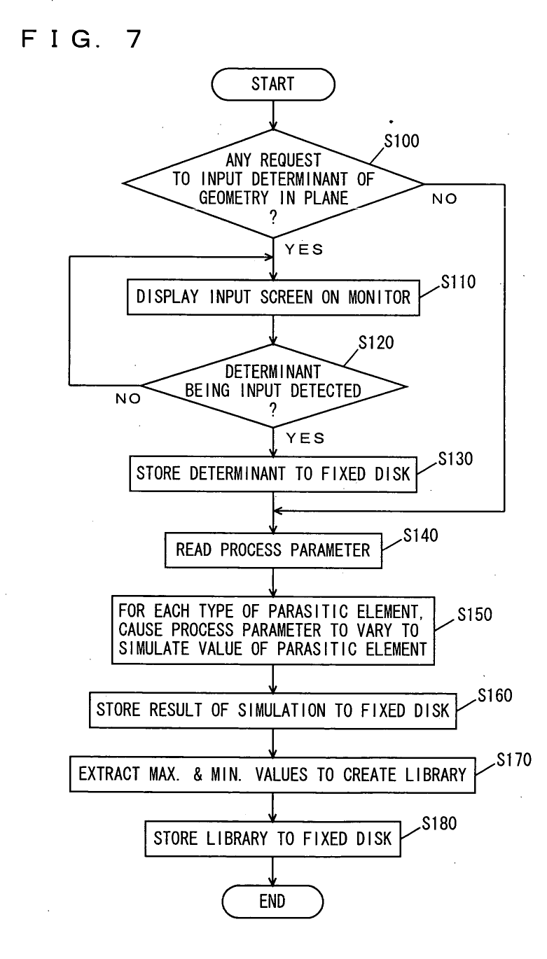

With reference to FIG. 7, a configuration for control of a program executed in computer system 100 by CPU 120 that implements a library creation process of the present method, will now be described.

At step (S) 100, CPU 120 determines whether a request has been made to input a determinant of geometry as seen in plane. This decision is made from information previously input by an operator. If the request has been made (YES at S100) then the process proceeds with S110. Otherwise (NO at S100) the process proceeds with S140.

At S100, CPU 120 controls monitor 104 to display an input screen. The operator refers to items displayed on monitor 104 for example to input or selects a determinant of geometry as seen in plane for a semiconductor integrated circuit, such as a wiring length, a wiring width, a wiring interval, a possibility of adjacent wiring, a possibility of overlapped wiring, a cell, and the like.

At S120, CPU 120 determines whether a determinant being input via keyboard 110, mouse 112 or the like has been detected. If so (YES at S120), the process proceeds with S130. Otherwise (NO at S120) the process returns to S110 and awaits the operator inputting a determinant.

S130, CPU 120 stores an input determinant to fixed disk 124. At S140, CPU 120 reads a process parameter previously stored in fixed disk 124. At S150, CPU 120 varies the determinant in value for each type of parasitic element (resistance, capacitance) while it also varies the process parameter (e.g., a wiring layer's film thickness, an oxide film's thickness and the like) to calculate the parasitic elements' values (resistance and capacitance values) through simulation, e.g., Monte Carlo simulation considering the possibility of occurrence. Furthermore, to determine the process parameter (a wiring layer's film thickness, an oxide film's thickness and the like)'s variation range, a chemical mechanical polishing (CMP) simulation capable of simulating an actual variation range is used, although the present invention is not limited to such particular simulation.

At S106, CPU 120 stores a result of the simulation at S150 to fixed disk 124. At S170, CPU 120 extracts maximum and minimum values from the result of the simulation for each type of parasitic element (resistance, capacitance) to create a library, which will be described hereinafter in detail. At S180, CPU 120 stores the library to fixed disk 124.

A library is thus created that stores maximum and minimum values of elements (resistance, capacitance) that are obtained when a process parameter (a wiring layer's film thickness, an oxide film's thickness and the like) is varied for each type of element and for each value thereof The library may be stored for each metal layer.

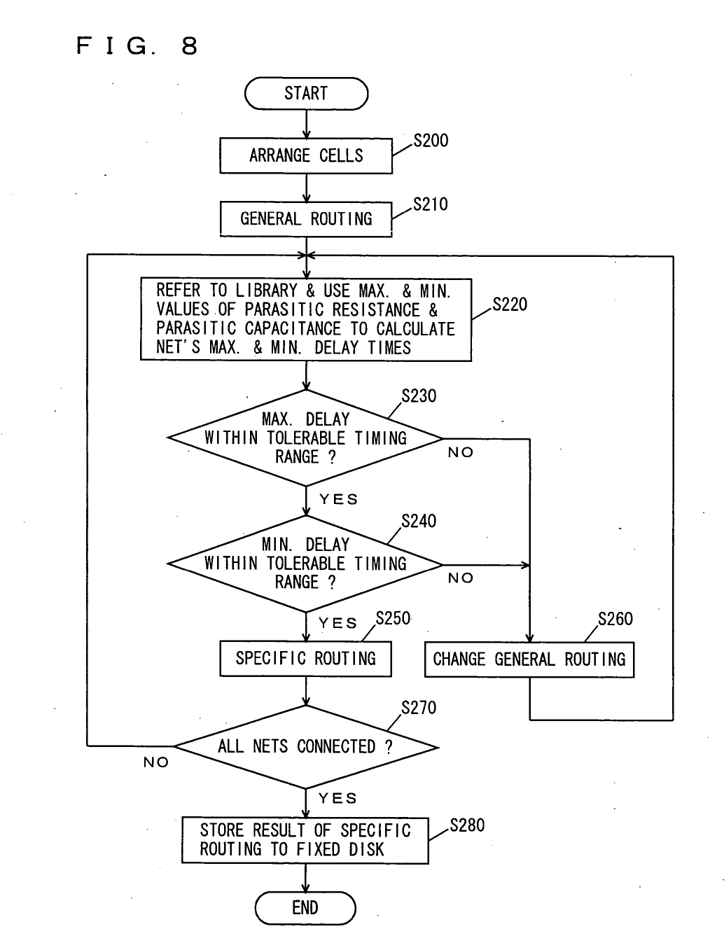

With reference to FIG. 8, a configuration of control of a program executed in computer system 100 by CPU 120 that implements a process performed to determine a routing in the present method, will now be described.

At S200, CPU 120 arranges standard cells in accordance with a net list extracted from a logic diagram. In doing so, as has been described previously, the cells are arranged so that (1) chip area is reduced and (2) a net's wiring length is minimized (see FIG. 3).

At S210, CPU 120 performs general routing for the arranged cell to determine a wiring route for each net. This is done for example by using a tree model or the like, as has been described previously (see FIG. 4).

At S220, CPU 120 refers to the library stored in fixed disk 124 to use maximum and minimum values of parasitic resistance and parasitic capacitance for each wire to calculate a net's maximum and minimum delay times.

At S230, CPU 120 determines whether the maximum delay time falls within a tolerable timing range set for the semiconductor integrated circuit. If so (YES at S230) the process proceeds with S240. Otherwise (NO at S230) the process proceeds with S260.

At S240, CPU 120 determines whether the minimum delay time falls within tolerable timing range set for the semiconductor integrated circuit. If so (YES at S230) the process proceeds with S250. Otherwise (NO at S230) the process proceeds with S260.

At S250, CPU 120 performs specific routing to determine a wiring route for each net. In this process, a rule in a technology file is followed and metal of first to third layers (more than a third layer in some case) are used to perform routing.

At S260, CPU 120 changes the general routing once performed at S210 to different general routing.

At S270, CPU 120 determines whether all nets have specifically been connected. If so (YES at S270) the process proceeds with S280. Otherwise (NO at S270) the process proceeds with S220.

At S280, CPU 120 stores to fixed disk 124 information of the specific routing created at S250.

Thus a previously stored library is referred to and maximum and minimum values of parasitic elements, or resistance, capacitance and the like, to perform a net's timing verification. Parasitic elements, or resistance, capacitance and the like, have values depending not only on a process parameter (a wiring layer's film thickness, an oxide film's thickness, and the like) but also the value of a determinant of geometry as seen in plane. These variation factors are considered in creating the library.

As based on such a configuration and flowchart as described above, the present method operates, as will be described hereinafter.

Library Creation Process

When an operator inputs a determinant of geometry as seen in plane (YES at S100) the operator uses keyboard 110, mouse 112 or the like to input such a determinant for a semiconductor integrated circuit as a wiring length, a wiring width, a wiring interval, a possibility of adjacent wiring, a possibility of overlapped wiring, a cell, and the like.

A process parameter is read from fixed disk 124 (S140). The process parameter varies within a range as calculated through CMP simulation. For each type of parasitic element (resistance, capacitance) the determinant is varied in value while the process parameter (a wiring layer's film thickness, an oxide film's thickness and the like) is varied to perform Monte Carlo simulation to obtain the parasitic elements' values (resistance and capacitance values).

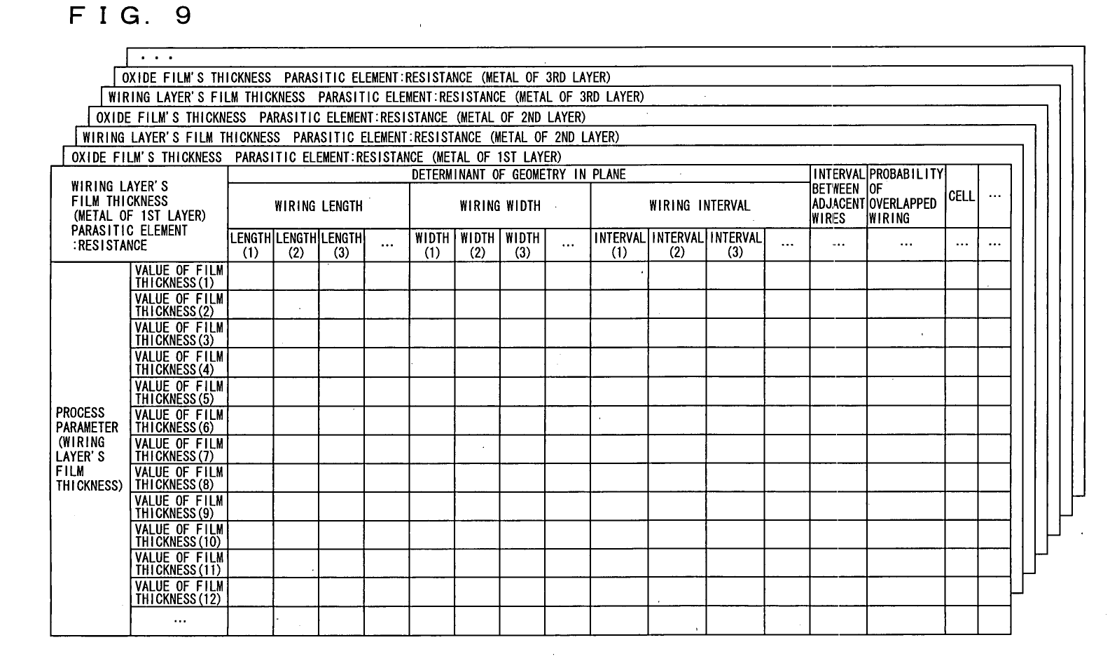

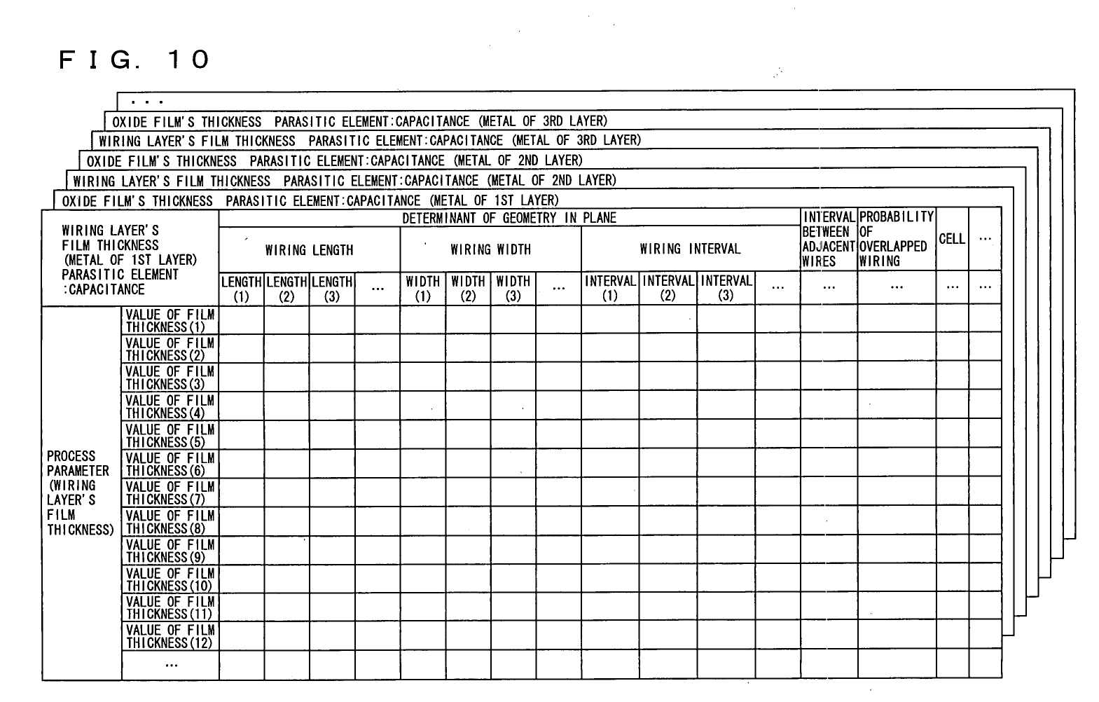

In connection therewith, FIGS. 9 and 10 show library data for an example with a parasitic element corresponding to resistance an example with a parasitic element corresponding to capacitance, respectively. As shown in FIGS. 9 and 10, a single data sheet is created for each of either a wiring layer's film thickness or an oxide film's thickness and for each metal layer. On the data sheet is set a value in film thickness of the process parameter (either the wiring layer's film thickness or the oxide film's thickness) set having reflected therein an actual configuration provided when CMP simulation is performed for calculation through simulation.

This film thickness value is varied, and a determinant of geometry as seen in plane, or wiring length, wiring width, wiring interval, the probability of adjacent wiring, the probability of overlapped wiring and the like, is set to a plurality of values to perform simulation to calculate resistance and capacitance values. Parasitic elements, or resistance, capacitance and the like, thus have their values stored to the matrix shown in FIGS. 9 and 10.

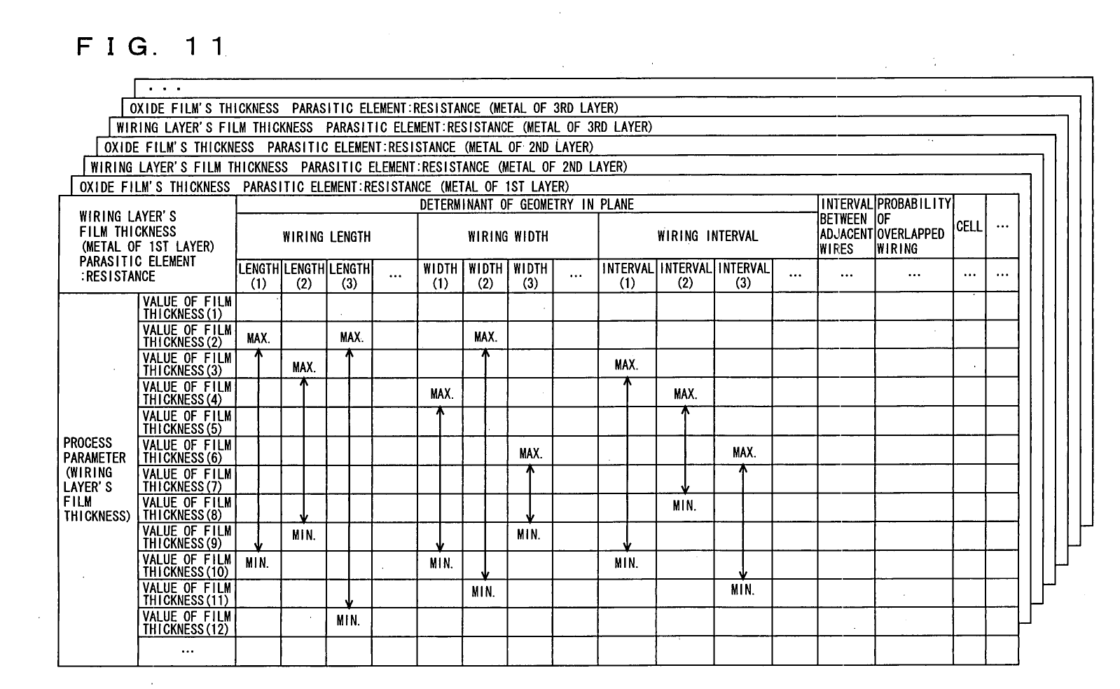

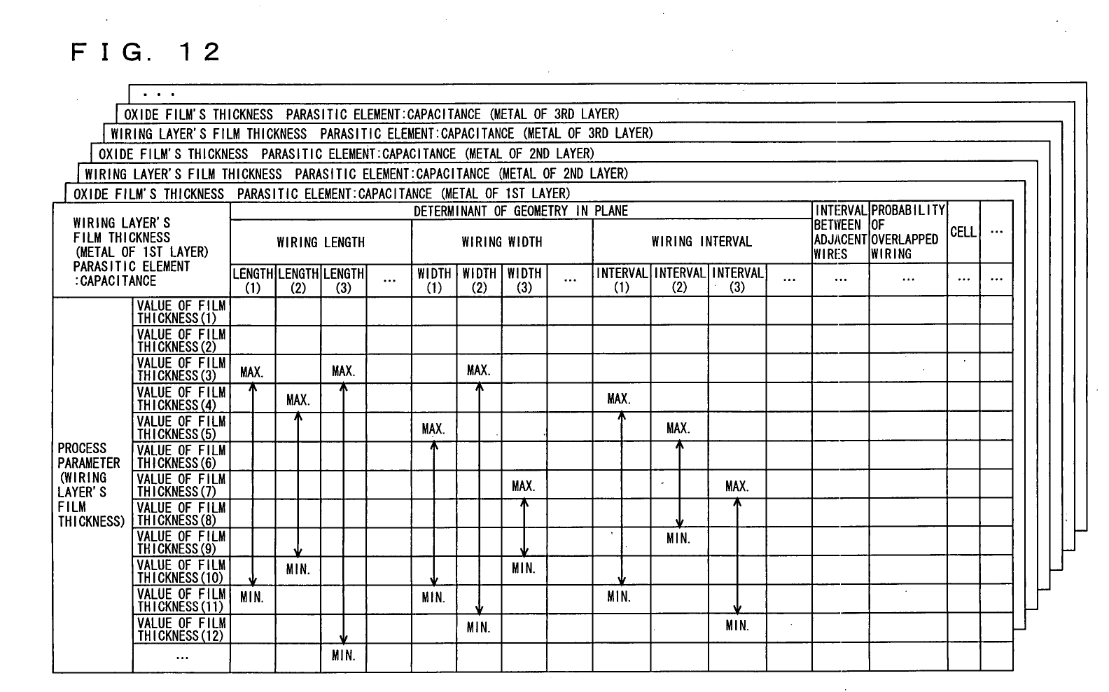

From the FIGS. 9 and 10 matrix storing values of parasitic elements including resistance, capacitance and the like, maximum and minimum values are extracted to create a library shown in FIGS. 11 and 12 (S170). As shown in FIGS. 11 and 12, maximum and minimum resistance (capacitance) values are extracted for each of a plurality of values of determinants of geometry as seen in plane including wiring length, wiring width, wiring interval, the possibility of adjacent wiring, the possibility of overlapped wiring, and the like. The extracted maximum and minimum resistance (capacitance) values indicate maximum and minimum values that can be assumed for a range allowing the process parameter to vary therein. The maximum and minimum values of each of the plurality of values of the determinant are used to perform a timing verification, and when the timing falls within a tolerable range, timing of operation will fall within tolerable range however the process parameter in semiconductor fabrication equipment may vary within a preset range.

Operation that Determines Wire Arrangement

As shown in FIG. 3, cells are arranged (S200), and as shown in FIG. 4, general routing is performed to determine a wiring route (S210). With reference to such a library as shown in FIGS. 11 and 12, resistance and capacitance values are used to calculate delay time for each wire and therefrom a net's maximum and minimum delay times are calculated (S220).

If the maximum delay time falls within a tolerable timing range (YES at S230) and the minimum delay time also falls within tolerable timing range (YES at S240), specific routing is performed to determine a wiring route (S250). Such a process is repeated until all nets are connected (YES at S270).

If the maximum or minimum delay time fails to fall within the tolerable timing range (NO at S230, NO at S240) then general routing is changed and a timing verification is performed.

Thus in the present embodiment the method employed to determine a wire arrangement previously librarizes a value of a parasitic element (resistance, capacitance) varying with a process parameter that is essential to a timing verification. A value of a flat geometry including a wiring length, a wiring width and the like, and a value in thickness of a wiring layer are referred to to read the corresponding resistance and capacitance values to calculate delay and perform a timing verification. This can eliminate the necessity of calculating wire resistance data and wiring capacitance data whenever a timing verification is performed, as conventional. A wire arrangement can thus be determined for a hierarchally structured semiconductor integrated circuit such that variation of a process parameter in a semiconductor integrated circuit fabrication process are considered and efficiently.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method employed to determine a wire arrangement, comprising the steps of:
automatically arranging a plurality of cells of a semiconductor integrated circuit, as based on a net list describing how said cells are connected, said semiconductor integrated circuit having a plurality of wiring layers used to wire said cells;
setting a general route including a lateral wire arrangement connecting cells located between said plurality of wiring layers;
previously creating information of a delay factor employed to calculate a value of delay between said cells from said general routing, said information varying with a process parameter in a process for fabricating the semiconductor integrated circuit, said information being created in a form applicable to a different semiconductor integrated circuit;
calculating a delay value of a net from said information and said general routing; and
if said delay value falls within a predetermined tolerable range, determining a specific routing between said cells, as based on said set general routing, in accordance with a rule in a technology file describing a design rule.

2. The method of claim 1, further comprising the step of resetting said general routing when said delay value fails to fall within said predetermined tolerable range.

3. The method of claim 2, wherein the step of previously creating includes the steps of:
previously storing information on a determinant of geometry as seen in plane for said semiconductor integrated device, said determinant including a wiring length, a wiring width, a wiring interval, a possibility of adjacent wiring, a possibility of overlapped wiring, and a cell; and
creating information on capacitance and resistance serving as said delay factor corresponding to a value of each said determinant, said capacitance and resistance being obtained as said process parameter is varied within a predetermined range.

4. The method of claim 1, wherein the step of previously creating includes the steps of:
previously storing information on a determinant of geometry as seen in plane for said semiconductor integrated device, said determinant including a wiring length, a wiring width, a wiring interval, a possibility of adjacent wiring, a possibility of overlapped wiring, and a cell; and
creating information on capacitance and resistance serving as said delay factor corresponding to a value of each said determinant, as obtained when said process parameter is varied within a predetermined range.

5. The method of claim 4, wherein the step of previously creating further includes the step of extracting maximum and minimum values of capacitance and resistance serving as said delay factor corresponding to a value of each said determinant, to create information storing said maximum and minimum values as correlated with the value of each said determinant, said maximum and minimum values being extracted as said process parameter is varied within a predetermined range.

6. The method of claim 5, wherein:
the step of calculating said net's delay value includes the step of calculating said net's delay value from maximum and minimum values correlated with the value of each said determinant; and
the step of determining said specific routing includes the step determining a specific routing between said cells when a delay value calculated from said maximum value and that calculated from said minimum value fall within a predetermined tolerable range.

7. The method of claim 4, further comprising the step of inputting a determinant of geometry as seen in plane for said semiconductor integrated circuit.

8. The method of claim 4, wherein said process parameter's predetermined range is set through a simulation.

9. The method of claim 1, wherein the step of previously creating information varying with said process parameter includes the step of employing a simulation to create said information varying with said process parameter in the process for fabricating the semiconductor integrated circuit.

10. The method of claim 1, wherein the step of previously creating information varying with said process parameter includes the step of creating in a form of a library said information varying with said process parameter in the process for fabricating the semiconductor integrated circuit.
